(19) United States
(12) Patent Application Publication
(10) Pub. No.: US 2025/0231661 A1
(43) Pub. Date: Jul. 17, 2025

(54) CONTEXTUAL POST-LOGIN INTERFACES FOR OPERATING SYSTEMS

(71) Applicant: GOOGLE LLC, Mountain View, CA (US)

(72) Inventors: Alexandra Hill Olds, London (GB); Nupur Jain, Sunnyvale, CA (US); Janet MacIntyre, Seattle, WA (US); Fan Zhang, San Jose, CA (US); Ajinkya Shirish Barve, Sunnyvale, CA (US); Miguel Ramirez, San Marino, CA (US); Xiaoqian Dai, Sunnyvale, CA (US)

(21) Appl. No.: 19/018,645

(22) Filed: Jan. 13, 2025

Related U.S. Application Data
(60) Provisional application No. 63/620,758, filed on Jan. 12, 2024.

(51) Int. Cl. G06F 3/04817

(52) U.S. Cl. CPC G06F 3/04817

(57) ABSTRACT

Techniques include providing a post-login user interface of an operating system that accelerates navigation by decreasing interactions a user has with the operating system after a successful login. In some implementations, the post-login user interface includes an informed restore user interface that enables a user to select which session items to restore after an unexpected shutdown, such as a crash or a non-user initiated shutdown, for example due to low battery, after a new session, or after a system update. The informed restore user interface may enable a user to select some, all, or none of the applications for restore. The informed restore user interface may provide smart suggestions to help a user resume a task.

### CROSS REFERENCE TO RELATED APPLICATION

This application claims the benefit of U.S. Provisional Application No. 63/620,758, filed Jan. 12, 2024, the disclosure of which is incorporated herein by reference in its entirety.

### BACKGROUND

Operating systems may require a user to log in after a system update, a system crash or other interruption (like running out of battery), a boot/reboot, etc. Users often use multiple devices to complete tasks and may have inefficiencies picking up tasks across devices and applications as well as tasks that get interrupted on a single device.

### SUMMARY

Implementations described herein are related to increasing user productivity when a user experiences a shutdown and reboot of an operating system. For example, implementations provide a customizable restore user interface and customized smart suggestions to increase user productivity by decreasing interactions with the computer to resume tasks, including tasks started on different applications and devices. For example, a customized restore user interface may be displayed in response to a successful login and may provide selectable objects representing portions of a previous session of the operating system. Accordingly, such a customized restore user interface enables the user to perform a partial, full, or no restore of the previous session. Moreover, the operating system may provide customized smart suggestions based on activity associated with a user account. In some implementations, the customized smart suggestions are represented by selectable user interface (UI) elements in the customizable restore user interface. In some implementations, the elements representing the customized smart suggestions are displayed based on a ranking of such customized smart suggestions.

In one general aspect, a method can include receiving an indication to provide a session overview. The method can also include, in response to determining to provide the session overview, identifying suggestions, based on a current time and trigger criteria, ranking the suggestions based on trigger categories and suggestion sources to produce a ranking, and presenting suggestion elements representing the suggestions according to the ranking.

In another general aspect, a computer program product comprising a nontransitory storage medium, the computer program product including code that, when executed by a processor, causes the processor to perform a method. The method can include receiving an indication to provide a session overview. The method can also include, in response to determining to provide the session overview, identifying suggestions, based on a current time and trigger criteria, ranking the suggestions based on trigger categories and suggestion sources to produce a ranking, and presenting suggestion elements representing the suggestions according to the ranking.

In another general aspect, a method can include determining, responsive to a successful login to an operating system, whether the successful login followed one of an unexpected shutdown or a system update. The method can also include, in response to determining that the successful login followed, during a previous session, one of an unexpected shutdown or a system update, displaying an object in a first user interface of the operating system, the object representing a portion of a previous session of the operating system, the object having a selection state, and in response to receiving an indication to restore the previous session, restoring the previous session of the operating system in a current session of the operating system in accordance with the selection state of the object, wherein the portion of the previous session is restored in the current session when the selection state of the object is an active state and the portion is excluded from the current session when the selection state of the object is an inactive state. The method can further include, in response to determining that the successful login did not follow one of an unexpected shutdown or a system update, displaying a desktop of the operating system in a second user interface.

The details of one or more implementations are set forth in the accompanying drawings and the description below. Other features will be apparent from the description and drawings, and from the claims.

### BRIEF DESCRIPTION OF THE DRA WINGS

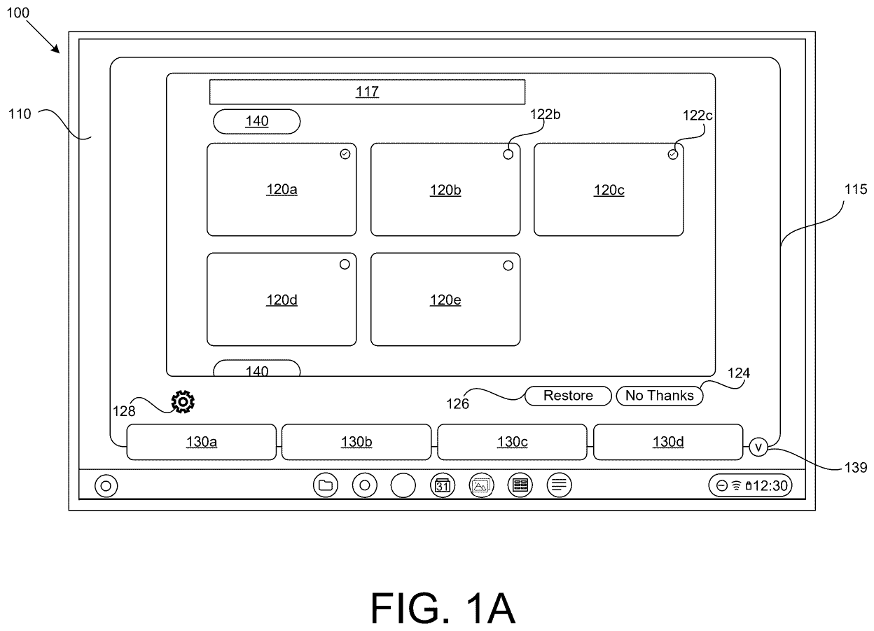

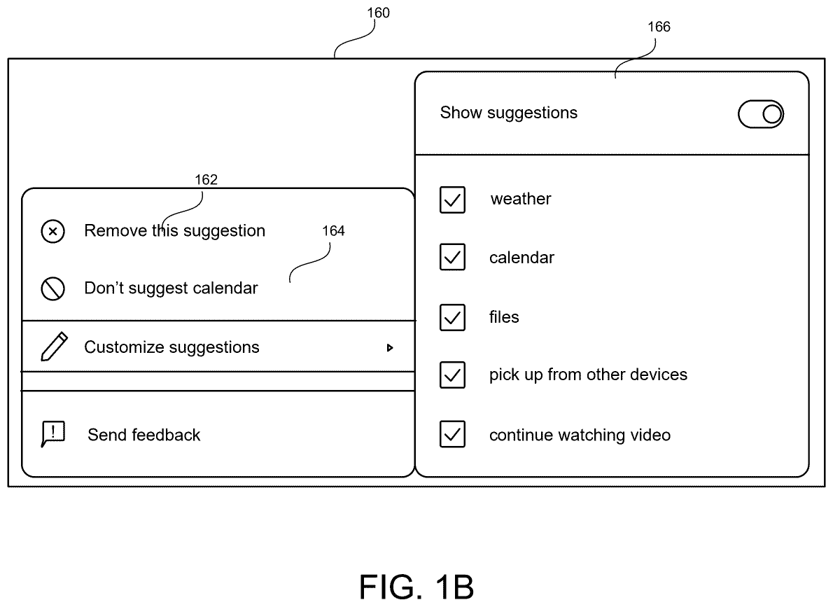

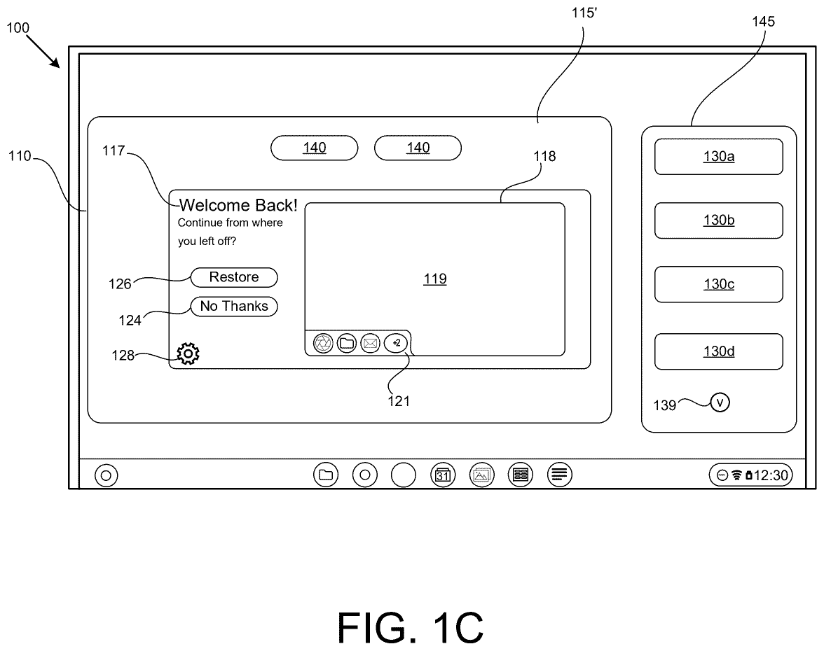

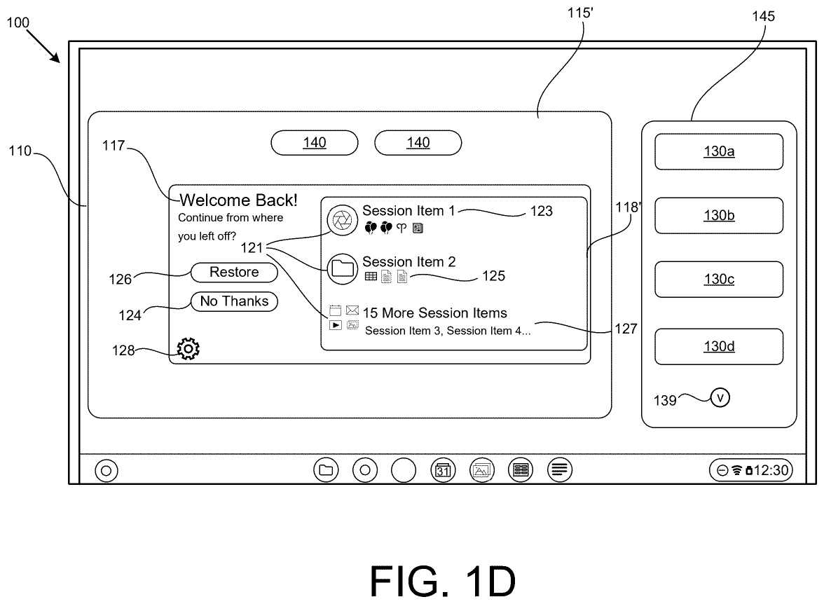

FIG. 1A is a diagram that illustrates a user interface of a computing device that displays an informed restore with smart suggestions, according to an aspect.

FIG. 1B is a diagram that illustrates one example of a suggestions settings user interface, according to an aspect.

FIG. 1C is a diagram that illustrates a user interface of a computing device that displays an informed restore with smart suggestions, according to an aspect.

FIG. 1D is a diagram that illustrates a user interface of a computing device that displays an informed restore with smart suggestions, according to an aspect.

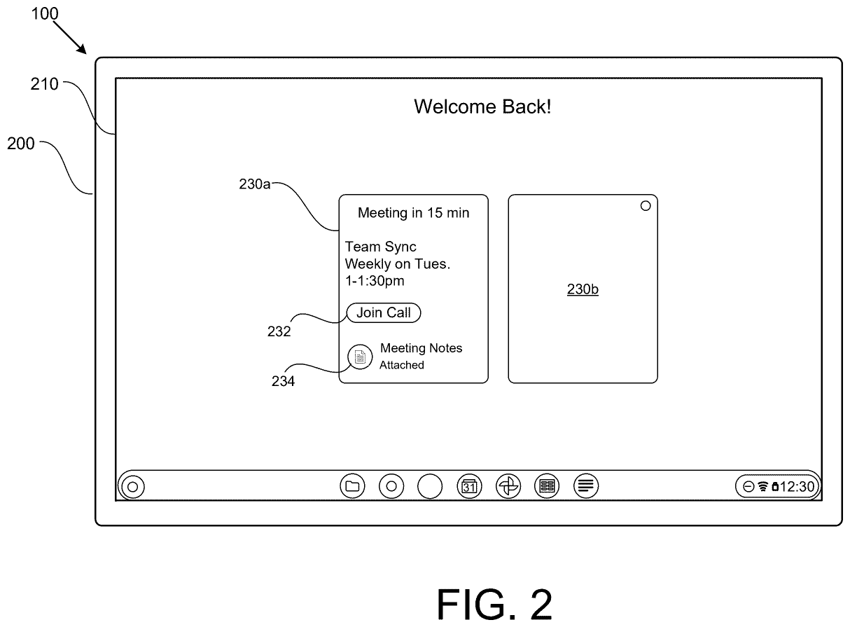

FIG. 2 is a diagram that illustrates a user interface of a computing device that displays a post-login desktop with a session overview, according to an aspect.

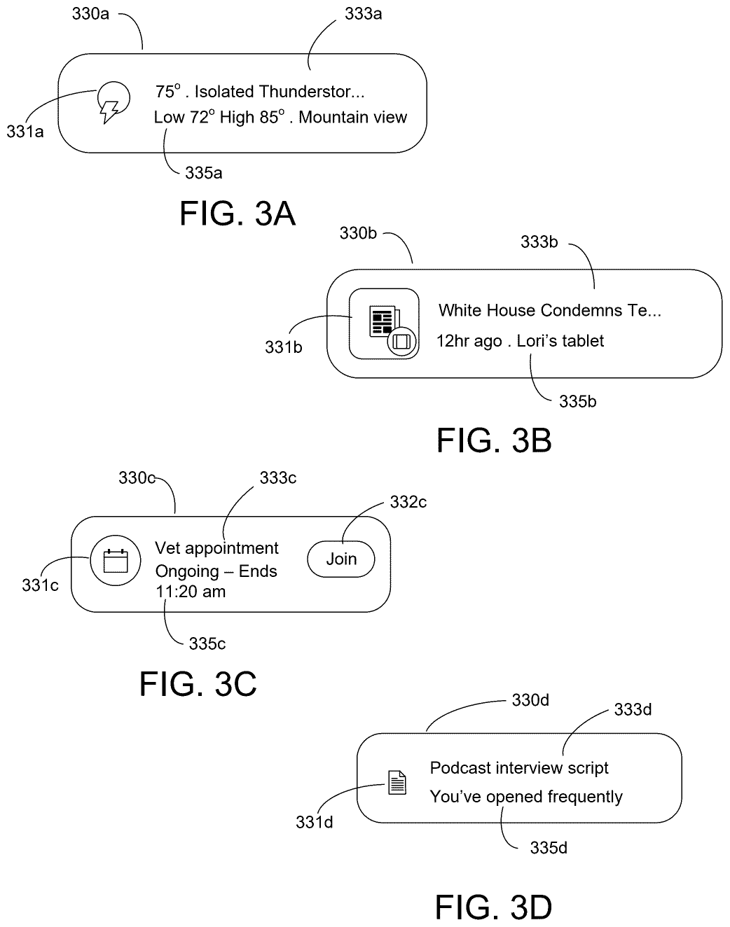

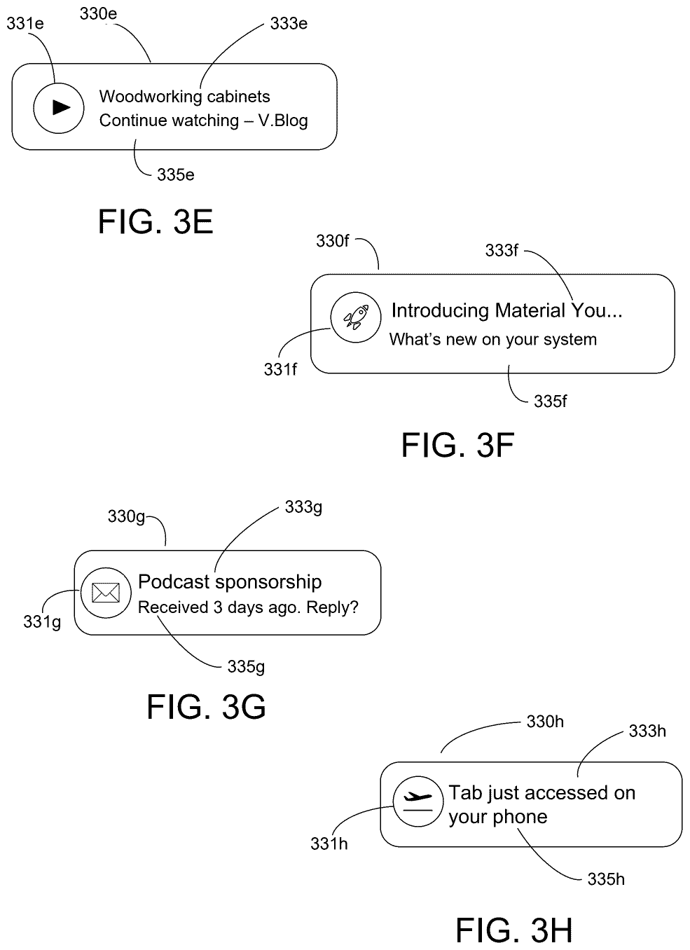

FIGS. 3A to 3H are diagrams that illustrate example smart suggestions, according to an aspect.

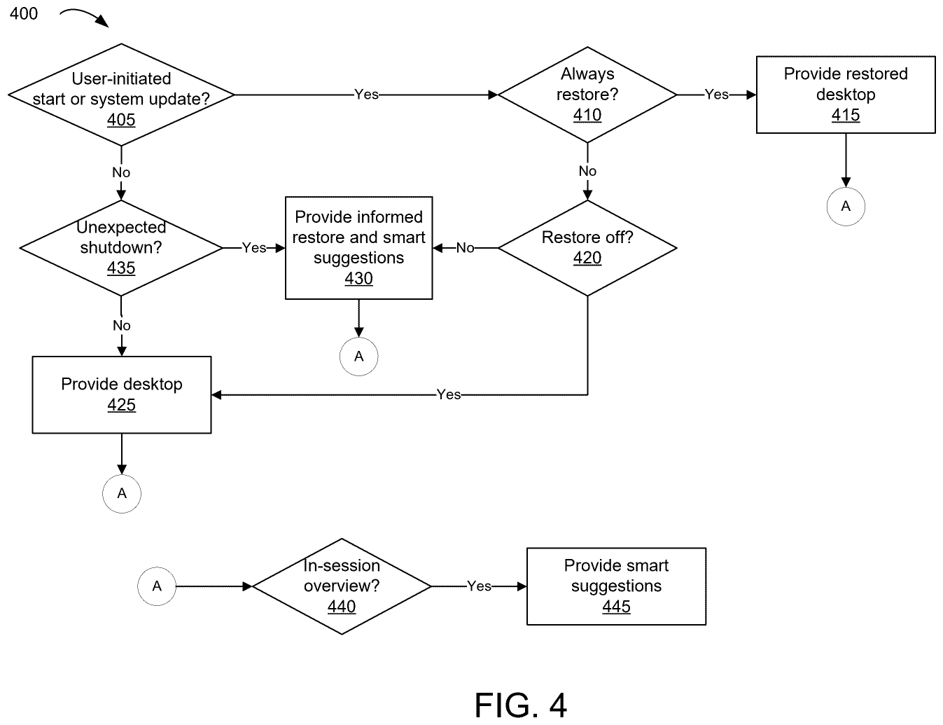

FIG. 4 is a flowchart that illustrates example operations for providing contextual post-login interfaces, according to an aspect.

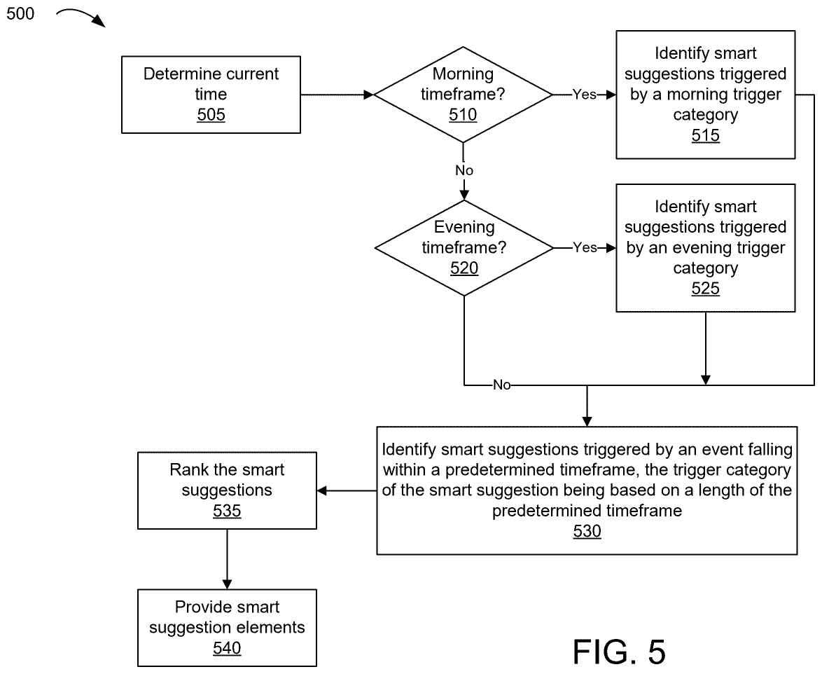

FIG. 5 is a flowchart that illustrates example operations for providing smart suggestions, according to an aspect.

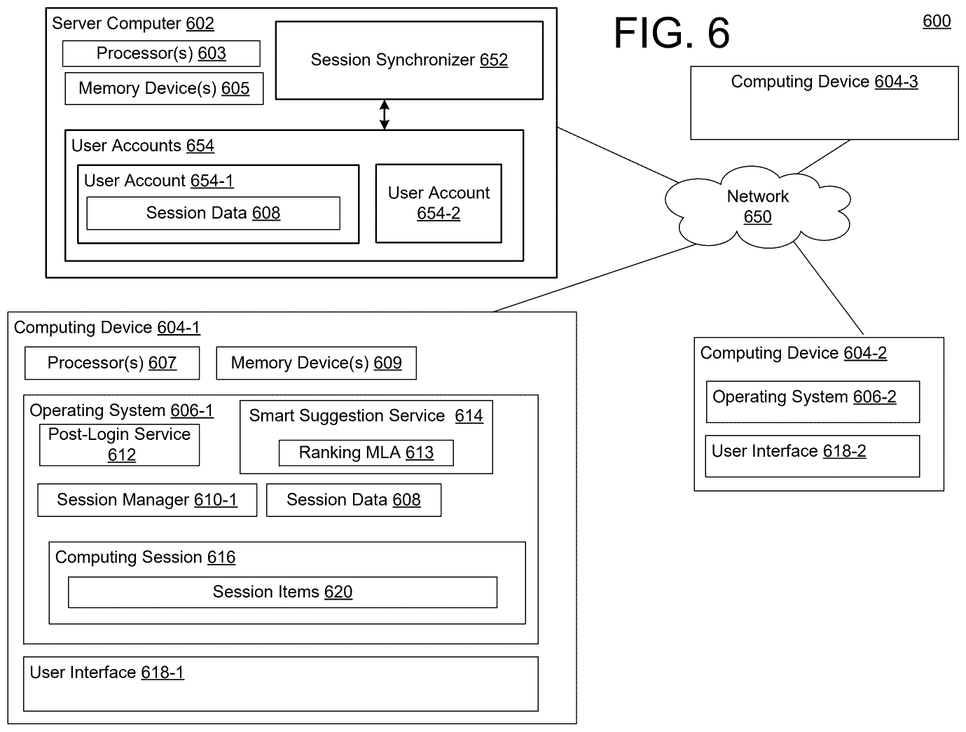

FIG. 6 is a diagram that illustrates a system for restoring one or more session items of a computing session according to an aspect.

### DETAILED DESCRIPTION

Operating systems that run on computing systems may shut down for any number of reasons. For example, an operating system may shut down from a session in response to a system update, a system crash or other interruption (like running out of battery), or a boot/reboot. Such an interruption may be user-initiated or non-user-initiated. In any case, after such an interruption, the user is required to log in to the operating system. After a successful login, a conventional operating system may load a desktop without restoring the previous session of the operating system, i.e., the session that was active before the operating system shut down.

A technical problem with conventional operating systems is that it is burdensome and inconvenient for the user to manually restore applications and settings that were active in the previous session of the operating system. Worse, it is even more burdensome for the user to have to restore applications and settings across multiple devices.

A technical solution to the technical problem involves an operating system providing a post-login user interface that accelerates navigation by decreasing interactions a user has with the operating system after a successful login. In some implementations, the post-login user interface includes an informed restore user interface that enables a user to select which session items to restore after an unexpected shutdown, such as a crash or a non-user initiated shutdown, for example due to low battery, after a new session, or after a system update. The informed restore user interface may enable a user to select some, all, or none of the applications for restore. The informed restore user interface may provide smart suggestions to help a user resume a task. The informed restore user interface may be provided in response to a user request after a successful login that follows a system update or a user-requested start. The informed restore user interface may be provided in response to a successful login that follows an unexpected system shutdown (e.g., a crash or a shut down due to low battery levels). If the successful login is not due to a user-initiated (expected) shutdown/restart and does not follow a system update or unexpected shutdown, implementations may provide a conventional desktop of the operating system, which lacks the ability to restore applications. Some implementations may enable a user to set a restore parameter value that indicates the system should always restore after a user-requested restart or after a system update, in which case the system may not provide the informed restore user interface and may instead provide a restored desktop with restored session items. In some examples, the session items (or a subset of the session items) (e.g., browser tabs/windows, web applications, native applications, display states, virtual desks, etc.) can be automatically restored, thereby minimizing the time needed to restore the computing session. As used herein, an application refers to any web application, native application, progressive web application, etc. executed by the operating system. Each application can be executed in a window within a desktop, a tab within a window, or user interface of the operating system apart from the informed restore user interface.

A technical advantage of the technical solution is that the post-login user interface enables a user to restore tasks, applications, and settings, e.g., session items, from a previous session of the operating system with far fewer operations (interactions with the operating system) than a conventional operating system. Moreover, the user is enabled, via an informed restore user interface, to perform a partial restore of the previous session by selecting only some and not all session items from the previous session. Further, the user is enabled via smart suggestions to activate tasks that may or may not have been active in the previous session. Moreover, the smart suggestions can activate such tasks across different devices associated with the same user account.

An operating system using disclosed implementations may provide a service that surfaces smart suggestions configured to help a user continue a task with fewer interactions with the operating system. The smart suggestions may have different sources and different triggering events that make the smart suggestions eligible for display. A suggestion source may be an application or service within which a triggering event occurs. A triggering event may be associated with a suggestion source. Implementations may use a ranking process to determine which smart suggestions to display to the user. The ranking process may be based on a trigger category. A trigger category may represent a category of triggering events. A trigger category may include a particular timeframe in which a triggering event occurs. A timeframe may belong to a trigger category. A trigger category can be a morning category. A morning category can include smart suggestions that are triggered by the current time of day falling in a timeframe defined as morning. For example, 5 am to 8 am may be a timeframe defined as morning. As another example, 6 am to 10 am may be a timeframe defined as morning. The timeframe defined as morning can be a parameter set by the user, a parameter set by a smart suggestion service, and/or a parameter set by the operating system. In some implementations, morning may be defined by a model that observes, with user permission, a timeframe when a user typically performs the first login process of a day. Implementations are not limited to the example timeframes listed above. Smart suggestions may be part of a morning trigger category when the smart suggestions are relevant to tasks or information a user may find useful after first signing-on in the morning.

A trigger category can be an evening category. An evening category can include smart suggestions that are triggered by the current time of day falling in a timeframe defined as evening. As an example, 5 μm to 8 pm may be a timeframe defined as evening. As another example, 6 μm to 10:30 pm may be a timeframe defined as evening. The timeframe defined as evening can be a parameter set by the user, a parameter set by a smart suggestion service, and/or a parameter set by the operating system. In some implementations, morning may be defined by a model that observes, with user permission, a timeframe when a user typically stops using the computing device for the day. Implementations are not limited to the example timeframes listed above. Smart suggestions may be part of an evening trigger category when the smart suggestions are relevant to tasks or information a user may find useful before logging off for the day.

A trigger category can be a recency trigger category. A recency trigger category can include smart suggestions that are triggered by an event occurring within a predefined recent time. Each suggestion source may have a different event to compare against the predefined recent time. The recent time can be within one hour. The recent time can be within a half hour. The recent time can be within some other time unit determined by a smart suggestion service, the operating system and/or the user. Implementations are not limited to the example predefined recent times listed above. Smart suggestions may be part of a recency trigger category when the smart suggestions are associated with events that a user may want to resume or start close to the current time.

Trigger categories may include a day trigger category. A day trigger category can include smart suggestions that are triggered by an event occurring within a day of the current time. These events can be a subset of the events that trigger a smart suggestion in the recency trigger category. Smart suggestions in the daily trigger category may be ranked lower than smart suggestions in the recency trigger category. Other trigger categories may include longer timeframes. As the timeframe increases, the trigger category may receive a lower rank. In other words, a smart suggestion that falls under a two-day trigger category would be ranked lower than a smart suggestion that falls under a day trigger category. Likewise, a smart suggestion that falls under a week trigger category is ranked lower than a smart suggestion that falls under a two-day trigger category. Put another way, the trigger categories may have a hierarchy, with trigger categories at the top of the hierarchy (e.g., morning triggers, evening triggers) having a higher rank than trigger categories at the bottom of the hierarchy. Trigger categories based on events occurring within a timeframe are lower in the hierarchy as their timeframe increases. In some implementations, the ranking of the smart suggestions is performed according to a model. For example, the model may take as input the trigger categories. In some implementations, the model may also take as input sources of the smart suggestions. The model may provide an ordered list of smart suggestions based on the trigger categories and/or input sources.

A smart suggestion, represented by a suggestion element is an interactive user interface element configured to help a user return to a task and/or remind a user about a task, thereby increasing productivity by reducing the number of interactions a user has with the operating system to perform a task after an interruption event. The interruption events can include any event that triggers the need for a user to complete a login process (i.e., successful login) before using the computing device. The interruption event can include a clean start (a boot) of the computing device, including a restart (reboot). An interruption event can include an unexpected system shutdown, due to a crash or low battery (which requires a reboot). An interruption event can include a system update (which requires a reboot).

FIG. 1A is a diagram that illustrates a user interface 110 of an operating system of a computing device 100 that displays an informed restore user interface 115 with suggestion elements 130, according to an aspect. The user interface 110 may be presented in response to a successful login after a crash event. The user interface 110 may be presented in response to a successful login after a system update. The user interface 110 may be presented in response to a system start (including a system restart) that is user-initiated. The user interface 110 may be presented in response to a system start after the computing device 100 shuts down due to low battery. The user interface 110 may be presented in response to a successful login after an interruption event depending on the value of a restore parameter. The user interface 110 may enable a user to resume one or more tasks with fewer interactions with the computing device 100.

The user interface 110 includes informed restore user interface 115. The informed restore user interface 115 may include a message portion 117. The message portion 117 may include text that provides a context for the informed restore user interface 115. The context of the informed restore user interface 115 depends on the restore eligible event that preceded the successful login that triggered the presentation of the informed restore user interface 115. Restore eligible events can include a system crash, a system update, a shutdown (a clean start), a restart (reboot), and/or a controlled crash (e.g., because of low battery). Thus, for example, the message portion 117 may be “Your computer restarted unexpectedly” when the restore eligible event was an unexpected system update (e.g., a crash or a controlled crash), “Your computer is up to date” when the restore eligible event was a system update, or “Welcome back!” when the restore eligible event is a clean start (e.g., a user-initiated shutdown or restart).

The informed restore user interface 115 includes one or more preview window objects 120 (e.g., preview window objects 120a to 120e) that each represent a session item to restore. The session items can represent programs that the operating system was executing before the restore eligible event, such as before an unexpected system update, before the system update, and/or when the computing device 100 received a user request to shutdown or restart the computing device. Session items can also represent controls and/or settings used by programs. The preview window objects 120 may display a screenshot of content associated with the session item from the last session. A session may be a time period after a successful login until a restore eligible event. A restore eligible event is any event that will require a new login process. A restore eligible event can include an unexpected system shutdown, an expected system shutdown (e.g., one initiated by the user), and/or a system update. The one or more preview window objects 120 can include detailed information describing the session item that the preview window represents. For example, the detailed information can include an icon that represents the session item, a title that represents the session item, a name of the session item, the number of open instances of the session item, etc. In some implementations, the detailed information may include a desk name where applicable. Some operating systems enable the user to have more than one desktop. In such operating systems, session items may be associated with a desktop and the informed restore user interface 115 or the one or more preview window objects 120 may provide an indication of which desktop the session item is associated with.

In some implementations, the one or more preview window objects 120 may include a respective restore control 122, such as restore control 122b for preview window object 120b and restore control 122c for preview window object 120c. A restore control 122 (e.g., restore control 122b) may be any user interface element that enables a user to select one of two selection states for any of the preview window objects 120. For example, a restore control 122 (e.g., restore control 122b) may be a radio button, a checkbox, a drop down with two choices, etc. If the preview window objects 120 each include a respective restore control 122 (e.g., preview window object 120b includes restore control 122b), the restore control 122 (e.g., restore control 122b) may be configured to provide its preview window object 120 (e.g., preview window object 120b) with a selection state, e.g., an active (e.g., selected) state or an inactive (e.g., unselected) state, giving the user control over which session items will be restored. In the example of FIG. 1A, two preview window objects 120b and 120c are selected (preview window objects 120b and 120c have an active state) and three are not selected (have an inactive state). In some implementations, the default state of a preview window object 120 is the selected state. Thus, the informed restore user interface 115 allows a user to perform a partial restore, a capability not provided in a conventional restore process.

In the example of FIG. 1A, the operating system enables the user to have more than one desktop and the informed restore user interface 115 includes desktop identifiers 140. The desktop identifiers may be text or an image that identifies the desktop. In the example of FIG. 1A, the informed restore user interface 115 is scrollable, so that the user can scroll to see the one or more preview window objects 120 associated with each desktop. In some implementations, the one or more preview window objects 120 may be shown for a first desktop and the desktop identifiers 140 may be user interface elements the user can interact with to change which preview window objects 120 are displayed in the informed restore user interface 115. Thus, a user may select a desktop identifier 140 to cause the user interface 110 to provide one or more preview window objects 120 associated with the selected desktop identifiers 140. The presence of the desktop identifiers 140 is optional.

The informed restore user interface 115 may include a restore approval control 126. The restore approval control 126 may be a selectable user interface element configured to, in response to selection by the user, cause the computing device 100 (e.g., the operating system) to restore the session items for which the associated preview window objects 120 have an active state. Selection of the restore approval control 126 may also result in removal of the informed restore user interface 115 and provide a desktop where the selected preview window objects 120 are opened. The associated session items may be opened to a last saved state. The informed restore user interface 115 may also include a cancel control 124. The cancel control 124 is a selectable user interface element that is configured to, in response to selection by the user, cause the computing device 100 (e.g., the operating system) to provide a desktop without restore. Selection of the cancel control 124 thus results in removal of the informed restore user interface 115 without restoring any of the session items.

The informed restore user interface 115 may also include a settings control 128. The settings control may be a selectable user interface element configured to, in response to selection by the user, cause the computing device 100 (e.g., the operating system) to provide a settings user interface for setting a restore parameter. The restore parameter may be set by the user. The restore parameter may be available in a user interface for setting operating system settings. Selection of the settings control 128 may result in display of a focused restore user interface that only includes parameters relevant to a post-login process. The restore parameter is relevant to the post-login process. The restore parameter may have predefined valid values. The focused restore user interface may allow the user to select a valid value for the restore parameter. For example, valid values for the restore parameter may be “always restore”, “ask”, or “none.” The informed restore user interface 115 may be presented when the value of the restore parameter is “ask,” as described in more detail with respect to FIG. 4. In some implementations, the informed restore user interface 115 may lack the settings control 128 when the 115 is generated (provided) in response to a system crash event.

The user interface 110 may include one or more suggestion elements 130, e.g., suggestion element 130a, 130b, 130c, 130d. Although illustrated as positioned at a bottom of the informed restore user interface 115 the suggestion elements 130 may be presented at a side of the informed restore user interface 115 or at a top of the informed restore user interface 115. The suggestion elements 130 may each represent a respective smart suggestion. For example, a smart suggestion may be a suggestion to perform a task in a current session of the operating system (e.g., a restored desktop). The suggestion elements 130 may be informational user interface elements determined to be relevant to the user based on the current time and triggering criteria. One or more of the suggestion elements 130 may be a selectable user interface element; accordingly, the suggestion elements may each have a respective selection state, e.g., active for a selected suggestion element 130, inactive for an unselected suggestion element 130. Selection of a suggestion element, e.g., suggestion element 130a, 130b, 130c, or 130d, may cause an application window corresponding to a source of the suggestion element to open. Thus, suggestion elements 130 may be configured to, in response to selection, cause a session item to be opened or to receive focus if the session item (e.g., application window) is already opened. Suggestion elements 130 are discussed in more detail with respect to FIGS. 3A to 3H.

In some implementations, the operating system may display a predetermined number of suggestion elements 130. If less than the predetermined number of smart suggestions are eligible for display, then the system may display fewer suggestion elements 130 than the predetermined number. In the example of FIG. 1A, the predetermined number is four. If more than the predetermined number of smart suggestions are eligible for display (meet trigger criteria that is based, in part, on a current time), the smart suggestions that are eligible for display based on the current time may be ranked, as described in more detail below with regard to FIG. 5. The predetermined number of top-ranked smart suggestions may be displayed as suggestion elements 130. In some implementations, the user interface 110 may include a suggestion expand control 139. The suggestion expand control 139 may be a selectable user interface element that expands the number of suggestion elements 130 displayed when selected a first time and contracts the suggestion elements 130 displayed to the predetermined number when selected a second time. Put another way, the control 139 may be toggled by a user to expand or contract the number of suggestion elements 130 displayed.

Implementations may enable a user to dismiss a smart suggestion. For example, the suggestion elements 130 may be configured to respond to an alt-selection gesture, such as a right-click, long press, etc., that differs from a conventional suggestion gesture, such as a left-click, short tap, short press, etc. In response to detection of an alt-selection gesture the selected suggestion element may provide a suggestions settings user interface. FIG. 1B illustrates one example of a suggestions settings user interface 160. The suggestions settings user interface 160 may include a button 162 to enable the user to dismiss the individual smart suggestion that corresponds to the selected suggestion element. If is the button 162 selected, future suggested events that have the same source and trigger criteria may not be eligible for display. The suggestions settings user interface 160 may include a button 164 to enable the user to dismiss a smart suggestion from a particular source. If the user dismisses smart suggestions from a particular source using the button 164, the system may not identify smart suggestions from that source as eligible for display. In some implementations, the suggestions settings user interface may allow a user to customize the sources eligible for generating smart suggestions using a customize interface 166, as illustrated in FIG. 1B.

FIG. 1C illustrates a user interface 110 of an operating system running on a computing device 100 that displays an informed restore user interface 115′ with suggestion elements 130, according to an aspect. The informed restore user interface 115′ is an alternative informative restore interface to informed restore user interface 115. The informed restore user interface 115′ may include a restore preview 118 window. The restore preview 118 may include a screenshot 119. The screenshot 119 may be a screenshot of the last active desktop displayed before the restore eligible event. The restore preview 118 may include icons 121. Each icon in the icons 121 represents a session item that will be restored in response to selection of the restore approval control 126. In some implementations, the restore preview 118 informed restore user interface 115′ may display up to n icons 121 for session items that will be restored in response to selection of the restore approval control 126, where n is a non-zero predetermined number. In the example of FIG. 1C n is three, but can be any non-zero integer. The informed restore user interface 115′ may display the icons 121 in order of recency, with the icon for the most recently accessed session item appearing first. If additional session items that will be restored exist, the last icon in the icons 121 may display the number of additional session items beyond n. The system may provide the informed restore user interface 115′ when there are more than two session items to restore. In some implementations, where there is a single session item to restore but with multiple instances (e.g., a browser with multiple open tabs), the icons 121 may represent icons for the instances, e.g., favicons for the web pages represented by the open tabs in the browser. The screenshot 119 may be a screenshot of the session item or may be a screenshot of the desktop. In implementations where the operating system is an operating system for a computing device 100 with a limited display area (e.g., a smart phone, a wearable device, etc.), where the system crashed, or where the system otherwise failed to take a screenshot before the system shutdown, the restore preview 118 may lack the screenshot 119 but may include the icons 121.

The example of FIG. 1C illustrates suggestion elements 130 on a side of the informed restore user interface 115′. In some implementations, as illustrated in the example of FIG. 1C, the suggestion elements 130 may be visually grouped by a user interface element 145. In some implementations, the suggestion elements 130 can be on the bottom of the informed restore user interface 115′, as illustrated in FIG. 1A. The suggestion elements 130 can also be on a top or a left side of the informed restore user interface 115′. Any grouping of the suggestion elements, including the user interface element 145, can also be referred to as a session overview.

FIG. 1D illustrates a user interface 110 of an operating system running on a computing device 100 that displays an informed restore user interface 115′ with suggestion elements 130, according to an aspect. The informed restore user interface is as in FIG. 1C, except that there is a restore preview 118′ that lacks a screenshot. For example, the system may have failed to capture a screenshot before an unexpected shutdown event, such as a crash or a low battery, or a screenshot that was captured may be considered too old. In such circumstances, or as an alternative to providing restore preview 118 some implementations may replace 118 with 118′, as illustrated in FIG. 1B. The restore preview 118′ may include an identifier 123 of the session item that corresponds with a particular icon of the icons 121. The session identifier 123 may be a title of the session item (e.g., an application name). The restore preview 118′ may also include icons 125 for the session item. The icons 125 may represent icons associated with instances of the session item. For example, where the session item is a browser application the icons 125 may represent favicons for web pages of the open tabs for the browser window (each browser window may be a different session item). Where the session item is a document application, the icons 125 may represent open documents. The restore preview 118′ may display a limited number of session items with corresponding icons, identifier 123, and icons 125. If additional session items are to be restored, these may be identified in a summary 127, as illustrated in the restore preview 118′. In some implementations, the restore preview 118′ may be used in response to an unexpected shutdown event.

FIG. 2 illustrates a user interface of an operating system running on a computing device 100 that displays a post-login desktop 200 with a session overview 210, according to an aspect. In some implementations, the session overview may be displayed in response to a user request to view the overview. In some implementations, the session overview may be displayed in response to the computing device 100 determining that a sleep mode or a screensaver mode has just ended, e.g., because the user has left the computer for some amount of time and has performed an action to end the sleep mode or screensaver mode. In some implementations, the user can control whether the session overview 210 is provided after waking from a sleep mode or screensaver mode (e.g., the user can turn off the session overview). The session overview 210 may include one or more suggestion elements 230, such as suggestion element 230a and suggestion element 230b. The one or more suggestion elements 230 may occupy more display space than the suggestion elements 130 of FIGS. 1A and 1B, so one or more suggestion elements 230 may be referred to as expanded suggestion elements and suggestion elements 130 may be referred to as condensed suggestion elements. An expanded suggestion element includes additional data, selectable user interface elements, and/or information that may not be included in the condensed suggestion elements. For example, the suggestion element 230a in the example of FIG. 1B represents a calendar application and includes not only a time until the scheduled calendar event, but details of the event (Team Sync; Weekly on Tues; 1-1:30 pm), a join user interface element 232, and an open attachment user interface element 234. In some implementations the condensed suggestion element may include the join user interface element 232 or the open attachment user interface element 234 but not both. Suggestion element 230b may represent a session item from a different source. The session overview 210 may be dismissed by opening an application or by selection of one of the suggestion elements 230 or a selectable user interface element such as join user interface element 232 or open attachment user interface element 234.

FIGS. 3A to 3H illustrate example suggestion elements 330, according to an aspect. The example suggestion elements 330 (e.g., suggestion elements 330a to 330h) can be similar to the suggestion elements 130 or the suggestion elements 230, as discussed herein. Thus, features and functionality discussed with respect to example suggestion elements 330 may apply to suggestion elements 130 and/or suggestion elements 230, and vice versa. The example suggestion elements 330 are non-limiting examples and implementations include suggestion elements and smart suggestions from sources not listed.

A suggestion element may include a title 333 (e.g., title 333a, 333b, 333c, 333d, 333c, 333f, 333g, 333h, etc.). A suggestion element may include a suggestion explanation 335, e.g., suggestion explanation 335a, 335b, 335c, 335d, 335e, 335f, 335g, 335h, etc.). The suggestion explanation 335 may reflect summary information for the suggestion, such as suggestion explanation 335a, suggestion explanation 335c, suggestion explanation 335f. The suggestion explanation 335 may reflect a rationale for displaying the suggestion, such as suggestion explanation suggestion explanation 335b, 335d, suggestion explanation 335c, suggestion explanation 335g, and suggestion explanation 335h. The suggestion explanation may reflect information about an event related to the smart suggestion, such as suggestion explanation 335b, suggestion explanation 335c, suggestion explanation 335g.

The suggestion elements 330 may include an icon 331 (e.g., icon 331a, icon 331b, icon 331c, icon 331d, icon 331e, icon 331f, icon 331g, icon 331h) associated with the source of the suggestion. The suggestion elements 330 represent suggestion elements from different suggestion sources, i.e., different source types. The icon 331, e.g., icon 331a, icon 331b, icon 331c, icon 331d, icon 331e, icon 331f, icon 331g, icon 331h, etc., may be an icon associated with/selected by the source of the suggestion.

The suggestion element 330a is an example of a smart suggestion from a weather source. The suggestion element 330b and the suggestion element 330h are examples of a smart suggestion from a source representing a session item (e.g., a tab) accessed from another device. Such session items may be synchronized, with user permission, via a user account. The user account may be the account the user successfully logged into. The suggestion element 330c is an example of a smart suggestion from a calendar source. In some implementations, a join user interface element 332c may be added to the suggestion element 330c. In some implementations, the join user interface element 332c may be added when the start time of the event is a meeting and the current time is within a predetermined time of the start time of the meeting. The suggestion element 330d is an example of a smart suggestion from a document repository source. The document repository source may be an application that provides access to documents (word processing documents, spreadsheets, presentation documents, PDF files, images, media files, etc.). The suggestion element 330c is an example of a smart suggestion from a media player source. The media player source can be any application executed by the operating system that enables a user to listen to audio or to listen and/or view video (including animations, simulations, etc.). The suggestion element 330f is an example of a smart suggestion from a system update source. The suggestion element 330f may be actionable to display the content of a “what's new” document/article/media repository. The suggestion element 330f may be triggered in response to a system update event when there is new content in the document/article/media repository. The suggestion element 330g is an example of a smart suggestion from a messaging source, such as an electronic mail application, a text messaging application, etc.

The operating system may access the sources via application program interfaces APIs provided by the source. Additional sources that may provide an API used to generate smart suggestions can include a task application, a map application, a project management application (including an application used in an educational or work environment to track tasks/assignments), etc. Thus, smart suggestions can include upcoming tasks, upcoming assignments, suggested locations, etc.

FIG. 4 illustrates a flowchart depicting example operations 400 for providing contextual post-login interfaces, according to an aspect. Although the operations 400 of FIG. 4 may be performed by an operating system, such as operating system 606 of FIG. 6, and/or the post-login service 612, the operations 400 may be applicable to any of the embodiments discussed herein. Although FIG. 4 illustrates the operations 400 in sequential order, it will be appreciated that this is merely an example, and that additional or alternative operations may be included. Further, operations of FIG. 4 and related operations may be executed in a different order than that shown, or in a parallel or overlapping fashion. The operations 400 represented by FIG. 4 may be performed in response to a successful login to the operating system. The operations 400 may be performed by a post-login service of the operating system.

The operations can include, at 405, determining whether an interruption event occurred and if the interruption event was a system update event or a user-initiated event (from an expected start/restart). If the successful login preceded a system update event or a user-initiated event (405, Yes), the system may determine the value of a restore parameter. The restore parameter may be set by a user as described above. If the restore parameter has a value that indicates the system should always restore, (410, Yes), at 415 the system may provide a restored desktop. This may be considered an automatic restore. If the restore parameter value does not indicate that the system should always restore, (410, No), but does indicate that no restore should be done (420, Yes), the system may provide a clean (unrestored) desktop at 425. If the value of the restore parameter indicates the user should be asked whether or not to restore (420, No), at 430 the system may provide an informed restore user interface, as described herein with respect to FIGS. 1A and 1B.

If after a successful login neither a system update event or a user-initiated start event has occurred (405, No), at 435 the system may determine whether an unexpected (e.g., a crash or low battery shut down) event occurred. If an unexpected shutdown has occurred (435, Yes), at 430 the system may provide an informed restore user interface, as described herein with respect to FIGS. 1A and 1B. If an unexpected shutdown has not occurred (435, No), at 425 the system may provide a clean (unrestored) desktop.

After the desktop has been provided, in some implementations, the system may provide an option to view an session overview. At 440 the system may determine whether an session overview should be displayed. The session overview may be a user interface the user can navigate to e.g., via a menu option, a shortcut, a keyboard sequence, a selectable icon, etc. If an session overview should be displayed, e.g., in response to a user request to display the overview, (440, Yes), at 445 the system may provide the overview, an example of which is described with respect to FIG. 2.

FIG. 5 illustrates a flowchart depicting example operations 500 for providing smart suggestions, according to an aspect. Although the operations 500 of FIG. 5 may be performed by an operating system, such as operating system 606 of FIG. 6, and in some cases by the smart suggestion service 614 of FIG. 6, the operations 500 may be applicable to any of the embodiments discussed herein. Although FIG. 5 illustrates the operations 500 in sequential order, it will be appreciated that this is merely an example, and that additional or alternative operations may be included. Further, operations of FIG. 5 and related operations may be executed in a different order than that shown, or in a parallel or overlapping fashion. The operations 500 represented by FIG. 5 may be performed as part of providing an informed restore, as discussed herein. The operations 500 represented by FIG. 5 may be performed in response to a user request. The operations 500 represented by FIG. 5 may be performed in response to identification of an interruption event. The operations 500 may be performed to provide a session overview.

The operations can include, at 505, determining a current time. The operations can further include, at 510, determining whether the current time is in a morning timeframe, e.g., belongs to a morning trigger category. For example, 5 am to 8 am may be a timeframe defined as morning. As another example, 6 am to 10 am may be a timeframe defined as morning. The timeframe defined as morning can be a parameter set by the user, a parameter set by a smart suggestion service, and/or a parameter set by the operating system. In some implementations, morning may be defined by a model that observes, with user permission, a timeframe when a user typically performs the first login process of a day. Implementations are not limited to the example timeframes listed above. Smart suggestions may be part of a morning trigger category when the smart suggestions are relevant to tasks or information a user may find useful after first signing-on in the morning.

The operations can include, if it is determined that the current time is in the morning timeframe, at 515, identifying smart suggestions triggered by a morning trigger category. A morning trigger category can include smart suggestions that are triggered by the current time of day falling in the morning timeframe. The smart suggestions may be identified by their sources. The suggestion source may correspond with an application. The suggestion source may correspond with a service (e.g., weather or explore smart suggestions). The suggestion source may correspond with a sync'd event, such as a website/link share, a media file resumption from another device, etc. Examples of smart suggestion sources in the morning trigger category are today's weather, calendar event, and attached file.

The suggestion sources may be associated with a trigger criterion. A trigger criterion may relate to the current time. The trigger criterion may relate to an event associated with the suggestion that occurs within some time period of the current time. For example, a trigger criterion for all sources in the morning trigger category specifies that the suggestion elements corresponding to the suggestions having the sources today's weather, calendar event, and attached file are only to be displayed between 5 am and 12 pm. Other, more specific criteria or triggers may be applied to the suggestion sources. For example, the today's weather suggestion element may be displayed in response to first login of the day. The calendar event suggestion element may be displayed in response to an ongoing or upcoming calendar event of the day. The attached file suggestion element may be displayed in response to a file being attached to an ongoing/upcoming calendar event.

In some implementations, the suggestion sources may be associated with a removal criterion, e.g., a criterion indicating when the suggestion can be removed. For example, the today's weather suggestion may be removed 30 minutes after a first impression or if opened. The calendar event and attached file suggestions may be removed after a first impression.

The operations can include, if it is determined that the current time is not in the morning timeframe, at 520, determining whether the current time is in an evening timeframe, e.g., belongs to an evening trigger category. An evening category can include smart suggestions that are triggered by the current time of day falling in a timeframe defined as evening. As an example, 5 μm to 8 pm may be a timeframe defined as evening. As another example, 6 μm to 10:30 pm may be a timeframe defined as evening. The timeframe defined as evening can be a parameter set by the user, a parameter set by a smart suggestion service, and/or a parameter set by the operating system. In some implementations, evening may be defined by a model that observes, with user permission, a timeframe when a user typically stops using the computing device for the day. Implementations are not limited to the example timeframes listed above. Smart suggestions may be part of an evening trigger category when the smart suggestions are relevant to tasks or information a user may find useful before logging off for the day.

The operations can include, if it is determined that the current time is in the evening timeframe, at 525, identifying smart suggestions triggered by an evening trigger category. An evening trigger category can include smart suggestions that are triggered by the current time of day falling in the evening timeframe. The smart suggestions may be identified by their sources. The suggestion source may correspond with an application. The suggestion source may correspond with a service (e.g., weather or explore smart suggestions). The suggestion source may correspond with a sync'd event, such as a website/link share, a media file resumption from another device, etc. Examples of smart suggestion sources in the morning trigger category are next day weather and first event next day. For example, a trigger criterion for the next day weather suggestion element is that the element is only displayed between 8 μm and 12 am. A trigger criterion for the first event next day suggestion element is that the element is only displayed between 5 μm and 12 am.

The operations can include, if it is determined that the current time is not in the evening timeframe, at 530, identifying smart suggestions triggered by an event falling within a predetermined timeframe, e.g., a recency timeframe. In this case, the trigger category of the smart suggestions is based on a length of the predetermined timeframe. For example, a recency trigger category can include smart suggestions that are triggered by the current time of day falling within an hour of an event. Example smart suggestion sources for this recency trigger category may include a website/link (triggered by a tab sent manually, criterion is that the tab was sent within one hour), a calendar event (triggered by an upcoming calendar event, criterion is that the event is starting in 30 minutes), attached file (triggered by a file being attached to an upcoming calendar event, criterion is that the event is starting in 30 minutes), website/link (triggered by a tab sent from other device, an example criterion being that the tab was sent within one hour), media player (triggered by the latest unfinished video, criterion being that the video was played within a predetermined threshold (e.g., 30 minutes, one hour, etc.) of the current time), document repository (triggered by the user modifying a file, an example criterion being that the modification was within a predetermined threshold (e.g., one hour, 90 minutes, etc.) of the current time), and drive file (triggered by the user having viewed a file, an example criterion being that the file was viewed within one hour).

In some implementations, the recency trigger category can include smart suggestions that are triggered by the current time of day falling within 24 hours of an event (e.g., a day trigger category). Example smart suggestion sources for this recency trigger category may include a Website/Link (triggered by a tab sent manually), media player (triggered by the latest unfinished video or audio file), website/link (triggered by a tab sent from another device), and document repository (triggered by the user modifying a file). The trigger criterion for all of these smart suggestion sources is that the events are within the past 24 hours of the current time. In some implementations, the recency trigger category can include smart suggestions that are triggered by the current time of day falling within 48 hours of an event. Example smart suggestion sources for this recency trigger category may include a tab from another device (triggered by the tab being sent manually). The associated smart suggestion may be removed when a link associated with the tab is selected and the content associated with the tab opened.

In some implementations, the recency trigger category can include smart suggestions that are triggered by the current time of day falling within seven days (a week) of an event. Example smart suggestion sources for this recency trigger category may include a media player (triggered by a recent video/audio file being added to a watch/listen later list) and a document repository (triggered by a user modifying a file).

In some implementations, the smart suggestions described above are generated using a model. In some implementations, the model is a large language model.

Once the smart suggestions and their categories, triggers, trigger criteria, and removal trigger have been identified, the operations can include, at 535, a ranking of the smart suggestions The ranking is produced from a ranking process such that a smart suggestion element is displayed in the user interface of the operating system when then ranking of the associated smart suggestion is sufficiently high. In some implementations, the ranking may be performed by arranging trigger categories in a hierarchy of trigger categories and locating a trigger category within the hierarchy. For example, smart suggestions in the daily trigger category may be ranked lower than smart suggestions in the recency trigger category. Other trigger categories may include longer timeframes. As the timeframe increases, the trigger category may receive a lower rank. In other words, a smart suggestion that falls under a two-day trigger category would be ranked lower than a smart suggestion that falls under a day trigger category. Likewise, a smart suggestion that falls under a week trigger category is ranked lower than a smart suggestion that falls under a two-day trigger category. Put another way, the trigger categories may have a hierarchy, with trigger categories at the top of the hierarchy (e.g., morning triggers, evening triggers) having a higher rank than trigger categories at the bottom of the hierarchy. Trigger categories based on events occurring within a timeframe are lower in the hierarchy as their timeframe increases.

In some implementations, the smart suggestions that are eligible for display can be ranked by a model configured to produce, as output, a ranking of the smart suggestions. In some implementations, the model takes the form of a machine learned ranking algorithm. The machine-learned ranking algorithm may use the features to describe the attributes of the smart suggestions (e.g., the source, the trigger category, what the satisfied triggering criteria is, etc.) to predict a ranking order for the smart suggestions. Thus, some of the operations of FIG. 5 may be automated by a machine-learned process.

In some implementations, when the model takes the form of a machine-learned ranking algorithm, the model may take the form of a neural network. In some implementations, the model may be trained using regression learning. In some implementations, the training data may include a user interaction history. In some implementations, the model may be initialized based on the hierarchy described above, or a different hierarchy. For example, in some implementations, and with user permission, the operating system may track a user's interactions with smart suggestions. Thus, if the user tends to select suggestion elements representing suggestions having today's weather as a source more than those having media player as a source, then suggestions having today's weather as a source will be weighted higher than suggestions having media player as a source for that user. Because the data is taken from a single user's history, the model training is performed on a device of the user (e.g., computing device 100). In some implementations, however, the model may be trained on a server based on data from multiple users, with user permission.

Further to the descriptions above, a user may be provided with controls allowing the user to make an election as to both if and when systems, programs, or features described herein may enable collection of user information (e.g., information about a user's selection of or dismissal of smart suggestions, information about timing of and patterns in the user's use of the computing device, a user's activities, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Once the smart suggestions are ranked, the operations can include, at 540, a providing of the smart suggestion elements representing the highest-ranked smart suggestions. For example, if there is a predetermined number N of smart suggestion elements to be displayed, then the top N ranked suggestions are displayed in respective display elements in a user interface of the operating system. If the number of suggestion elements displayed is increased, e.g., via suggestion expand control 139 (FIG. 1A), then the next ranked suggestions are displayed via their respective suggestion elements.

FIG. 6 illustrates a system 600 for restoring one or more session items of a computing session according to an aspect. In some examples, the computing session 616 can be restored in response to a smart suggestion service 614. In some examples, the computing session 616 can be synchronized across multiple devices (e.g., computing device 604-1, computing device 604-2).

The computing device 604-1 is a device having an operating system 606-1 that renders a user interface 618-1 (e.g., a graphical user interface (GUI)), which allows the user to interact with the functionalities of the computing device 604-1. In some examples, the computing device 604-1 includes a personal computer, a mobile phone, a tablet, or a laptop. The computing device 604-1 may include one or more processors 607 formed in a substrate configured to execute one or more machine executable instructions or pieces of software, firmware, or a combination thereof. The processors 607 can be semiconductor-based—that is, the processors can include semiconductor material that can perform digital logic. The computing device 604-1 may include one or more memory devices 609. The memory devices 609 may include a main memory that stores information in a format that can be read and/or executed by the processors 607. The memory devices 609 may store applications (e.g., operating system 606-1, applications, etc.) and modules (e.g., session manager 610-1, post-login service 612, etc.) that, when executed by the processors 607, perform certain operations.

The operating system 606-1 is a system software that manages computer hardware, software resources, and provides common services for computing programs. In some examples, the operating system 606-1 is operable to run on a personal computer such as a laptop, a desktop computer, or a smart television. In some examples, the operating system 606-1 is operable to run a mobile computer such as a smartphone, a smart wearable, a tablet, etc. The operating system 606-1 may include a plurality of modules such as a session manager 610-1, a smart suggestion service 614, and a post-login service 612.

As shown in FIG. 6, the smart suggestion service 614 includes a ranking engine 613. The ranking engine 613 may be a machine-learned ranking algorithm may use the features to describe the attributes of the smart suggestions (e.g., the source, the trigger category, what the satisfied triggering criteria is, etc.) to predict a ranking order for the smart suggestions. Details of the ranking engine are described above with regard to FIG. 5.

In some examples, the computing device 604-1 may communicate with a server computer 602 over a network 650. In some examples, the server computer 602 stores user accounts 654 for users of the various computing devices of the system 600. In some examples, although not shown in FIG. 6, the computing device 604-1 stores one or more user accounts 654 that pertain to the authorized users of the computing device 604-1. A user account 654 may store information pertaining to the user such as a profile of the user and/or information obtained through the user's use of the computing device 604-1 when authorized by the user.

For example, a user of the computing device 604-1 may be provided with controls allowing the user to make an election as to both if and when systems, programs, or features described herein may enable collection of user information (e.g., information about a user's activities, a user's preferences, or a user's current location), and whether the user is sent content or communications from the server computer 602. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the computing device 604-1 may have control over what information is collected about the user, how that information is used, and what information is provided to the user and/or to the server computer 602.

The server computer 602 may be computing devices that take the form of a number of different devices, for example a standard server, a group of such servers, or a rack server system. In some examples, the server computer 602 may be a single system sharing components such as processors and memories. The network 650 may include the Internet and/or other types of data networks, such as a local area network (LAN), a wide area network (WAN), a cellular network, satellite network, or other types of data networks. The network 650 may also include any number of computing devices (e.g., computer, servers, routers, network switches, etc.) that are configured to receive and/or transmit data within network 650. Network 650 may further include any number of hardwired and/or wireless connections.

The server computer 602 may include one or more processors 603 formed in a substrate, an operating system (not shown) and one or more memory devices 605. The memory devices 605 may represent any kind of (or multiple kinds of) memory (e.g., RAM, flash, cache, disk, tape, etc.). In some examples (not shown), the memory devices 605 may include external storage, e.g., memory physically remote from but accessible by the server computer 602. The server computer 602 may include one or more modules or engines representing specially programmed software. For example, the server computer 602 may include a session synchronizer 652 that enables user information, such as session items, to be synced across multiple devices such as computing device 604-1 and computing device 604-2.

The computing device 604-2 is a device having an operating system 606-2 that renders a user interface 618-2 (e.g., a graphical user interface (GUI)), which allows the user to interact with the functionalities of the computing device 604-2. In some examples, the computing device 604-2 includes any of the features discussed with respect to the computing device 604-1. Also, although not shown in FIG. 6, the computing device 604-2 may include one or more processors (e.g., processors 607) and one or more memory devices (e.g., memory devices 609). In some examples, the computing device 604-2 includes a personal computer, a mobile phone, a smart wearable, a smart television, a tablet, or a laptop. In some examples, the computing device 604-2 is the same type of device as computing device 604-1 (e.g., both are laptops, tablets, smartphones, etc.). In some examples, the computing device 604-1 and the computing device 604-2 are different types of devices (e.g., one is a laptop, the other one is a tablet, etc.). In some examples, the operating system 606-2 is the same type of operating system as the operating system 606-1.

A user may access a user account 654-1 on the computing device 604-1, which may include providing a username/password or other type of authentication credential. Successful access to the user account 654-1 may provide access to the functionalities of the computing device 604-1. The user account 654-1 may be one of the user accounts 654, which pertains to the user of the computing device 604-1. In some examples, the user may be associated with another user account, e.g., user account 654-2. For example, the user may be associated with a primary account (e.g., user account 654-1) and a secondary account (e.g., user account 654-1), where access to either of the primary account or the secondary account provides access to the computing device 604-1. In some examples, the user account 654-1 and the user account 654-2 pertains to different users. For example, user A may provide her authentication credential, which, when authorized, provides access to the computing device 604-1. User B may provide her authentication credential, which, when authorized, provides access to the computing device 604-1. In some examples, the computing device 604-1 displays a login screen to permit the user to supply the user's credential, which, when authenticated, allows the user to access the functionalities of the computing device 604-1. In some examples, a computing session 616 starts in response to a successful login using the user account 654-1 (or, in some examples, user account 654-2). In some examples, the computing session 616 may be referred to as an operating system (OS) session.

During the computing session 616, the operating system 606-1 (e.g., the session manager 610-1) generates session data 608. The session data 608 includes information about session items 620 used by the user during the computing session 616. The session items 620 may include programs, controls, and/or settings used by the user during the computing session 616. The session items 620 may include applications, display states, virtual desks, and/or graphical control elements. The graphical control elements may include user interface elements pertaining to other types of programs or controls such as files, windows, and/or control screens.

An application may be any type of computer program that can be executed/delivered by the computing device 604-1. An application may provide a user interface (e.g., application window) on the user interface 618-1 to allow the user to interact with the functionalities of a respective application. The application window of a particular application may display application data along with any type of controls such as menu(s), icons, widgets, etc.

The applications may include browser applications. A browser application is a web browser configured to access information on the Internet. The browser application may launch one or more browser tabs in the context of one or more browser windows on the user interface 618-1. The applications may include web applications. A web application may be an application program that is stored on a remote server (e.g., a web server) and delivered over the network 650 through the browser tab. In some examples, the web application is a progressive web application, which can include elements saved on the device and used offline. The application may include non-web applications, which may be programs that are at least partially stored (e.g., stored locally) on the computing device 604-1. In some examples, non-web applications may be executable by (or running on top of) the operating system 606-1.

The applications may include native applications. A native application is a software program that is developed for use on a particular platform or device. In some examples, the native application is a software program that is developed for multiple platforms or devices. In some examples, the native application is a software program developed for use on a mobile platform and also configured to execute on a desktop or laptop computer.

The display states may include any type of state or mode relating to the user interface display. In some examples, the display states include a split screen feature. When the split screen feature is enabled, the user interface 618-1 is vertically or horizontally split, thereby allowing the user to view two applications side-by-side or view multiple sections of the same document or multiple files at once. In some examples, the display states include a picture-in-picture feature. The picture-in-picture feature is a program that permits a video to be displayed in the foreground while the user can interact with other applications. In some examples, the picture-in-picture feature is a popped out, always-on-top video player that floats on top of other windows. In some examples, the display states include full screen mode. Full screen mode permits a particular program to occupy the entire screen of the user interface 618-1 (or substantially the entire screen of the user interface 618-1). In some examples, the full screen mode includes a maximized mode in which the window takes the entire screen that is not occupied by the system UI. In some examples, the full screen mode includes the entire screen in which the window takes the entire screen including the space previously occupied by the system UI. In some examples, the display states include multiple physical displays. For example, a device may be associated with a first display screen and a second display screen (or more than two display screens).

The virtual desks may be considered virtual desktops, workspaces, or desktop objects and are used to expand the size of the desktop on the user interface 618-1 or used to group (application) windows. A user may create a virtual desk, also referred to as a desktop, which allows the user to open and manipulate various applications, graphical control elements, and display states. For example, with respect to the virtual desk (desktop), the user may enable a split screen feature, launch a web application on one part of the user interface 618-1, and launch a native application on the other part of the user interface 618-1. Then, the user may create a virtual desk to open and display one or more browser tabs to execute one or more personal tasks such as planning a trip. A user may be able to switch between a first virtual desk (a first desktop) and a second virtual desk (a second desktop).

During the computing session 616, a user may launch and manipulate browser tabs and/or browser windows on the user interface 618-1. In some examples, the user may launch a web application, and a native application, which displays application windows on the user interface 618-1. In some examples, the user may set up one or more virtual desks and/or enable a split screen feature on the computing device 604-1. In some examples, the user may enter a full screen mode, and/or establish a picture-in-picture feature on the user interface 618-1. In some examples, the user may open and position one or more graphical control elements on the user interface 618-1.

As the user launches and/or manipulates the session items 620 on the user interface 618-1, the session manager 610-1 generates session data 608 about the session items 620. The session data 608 may include an identification of which session item 620 has been launched (e.g., started), window positions (and window sizes) of the applications and/or graphical control elements on the user interface 618-1, whether an application is positioned in the foreground or background, whether an application is focused or non-focused, the time in which the session items 620 were used (or last used), and/or a recency or last appearance order of the session items 620. In some examples, the session data 608 may include session item assignment to virtual desk and/or physical display (in multi-display setup). For example, the session data 608 may identify which application (or generally which session item 620) is assigned to which virtual desk. Also, the session data 608 may identify which application (or generally which session item 620) is displayed on which physical display (if a multi-display setup is used). In some examples, the session data 608 may include application navigation state (e.g., activity stack or other identification of a screen that the application was displaying). For example, with respect to a particular application, the session data 608 may include information about the underlying navigation state, e.g., identification of a screen that the application was displaying.

In some examples, the session manager 610-1 stores the session data 608 within the memory device 609. In some examples, the session manager 610-1 transmits the session data 608, over the network 650, to the server computer 602 (e.g., to the session synchronizer 652) in which the session data 608 is stored in association with the user account 654-1 (or the user account 654-2) of the user at the server computer 602. For example, as the user establishes a session item 620 on the user interface 618-1, the session manager 610-1 transmits session data 608 about the session item 620 to the server computer 602. At the server computer 602, the session synchronizer 652 stores the session data 608 at the user account 654-1. Obtaining recently opened tabs from computing device 604-2 is an example of session data 608 transmitted to computing device 604-1.

In some examples, the user logs out of the user account 654-1 (or the user account 654-2) on the computing device 604-1 with the session items 620 still active on the user interface 618-1. A session item 620 that is active may refer to a session item 620 that is not closed (or terminated). For example, an application opened by the user that is running in the background or foreground may be considered a session item 620 that is active. A split screen feature that is enabled may be considered a session item 620 that is active. In some examples, the user does not log out of the user account 654-1 (or the user account 654-2) of the computing device 604-1 but leaves the computing device 604-1 with the session items 620 still active on the user interface 618.

In some examples, after logging in, the computing session 616 is restored on the computing device 604-1. The computing session 616 can be automatically restored or used to generate an informed restore interface, such as informed restore user interface 115, informed restore user interface 115′, etc. The session data 608 is configured to be used by the operating system 606-1 of the computing device 604-1 to restore the session items 620 on the user interface 618-1 of the computing device 604-1. If a restore is performed (e.g., automatically, or via the informed restore user interface), one or more of the session items 620 included in the computing session 616 can be restored. As discussed herein, the informed restore user interface may provide the user with an opportunity to perform a partial restore. For a session item 620 that is an application and that is restored, the application is launched and displayed on the user interface 618-1. If the session items 620 include one or more display states, the display states can be enabled in substantially the same manner as they were before the interruption event.

In some examples, the operating system 606-1 of the computing device 604-1 synchronizes the session items 620 with other computing devices used by the user account (e.g., computing device 604-2, computing device 604-3) with user consent for synchronization across multiple devices during the device startup.

In some aspects, the techniques described herein relate to a method including: determining, responsive to a successful login to an operating system, whether the successful login followed a system update or an unexpected shutdown; in response to determining that the successful login followed a system update or an unexpected shutdown, providing an informed restore and smart suggestions; and in response to determining that the successful login did not follow a system update or an unexpected shutdown, providing a desktop of the operating system.

In some aspects, the techniques described herein relate to a method including: receiving an indication to provide a session overview; and in response to determining to provide the session overview, identifying suggestions, based on events associated with suggestion sources and occurring in timeframes belonging to trigger categories, ranking the suggestions based on the trigger categories and the suggestion sources to produce a ranking, and presenting suggestion elements representing the suggestions according to the ranking.

In some aspects, the techniques described herein relate to a method, further including: wherein a trigger category of the trigger categories is a morning category associated with a morning timeframe and a suggestion of the suggestions is identified when a current time falls within the morning timeframe.

In some aspects, the techniques described herein relate to a method, further including: wherein a trigger category of the trigger categories is an evening category associated with an evening timeframe and a suggestion of the suggestions is identified when a current time falls within the evening.

In some aspects, the techniques described herein relate to a method, further including: wherein a suggestion of the suggestions is identified when an event occurs.

In some aspects, the techniques described herein relate to a method, further including: determining whether to provide an in-session overview; and in response to determining to provide the in-session overview: identifying eligible smart suggestions, based on time of day and trigger criteria; ranking the smart suggestions based on trigger category and suggestion source, and providing the smart suggestions in an order determined by the ranking.

In some aspects, the techniques described herein relate to a method, wherein the trigger category is morning and the trigger criteria includes a combination of the current time and a suggestion source.

In some aspects, the techniques described herein relate to a method, wherein the trigger category is evening and the trigger criteria includes a combination of the current time and the suggestion source.

In some aspects, the techniques described herein relate to a method, wherein the trigger criteria includes a combination of an event occurrence and the suggestion source.

In some aspects, the techniques described herein relate to a method, wherein the trigger category includes morning, within an hour, evening, and within a day.

In some aspects, the techniques described herein relate to a method, wherein the trigger category further within two days and within seven days.

In some aspects, the techniques described herein relate to a method, including: determining, responsive to a successful login to an operating system, whether the successful login followed one of an unexpected shutdown or a system update; in response to determining that the successful login followed, during a previous session, one of an unexpected shutdown or a system update: displaying an object in a user interface of the operating system, the object representing a portion of a previous session of the operating system, the object having a selection state; in response to receiving an indication to restore the previous session, restoring the previous session of the operating system in a current session of the operating system in accordance with the selection state of the object, wherein the portion of the previous session is restored in the current session when the selection state of the object is an active state and the portion is excluded from the current session when the selection state of the object is an inactive state; and in response to determining that the successful login did not follow one of an unexpected shutdown or a system update, displaying a desktop of the operating system.

In some aspects, the techniques described herein relate to a method, wherein the object is a first object and the portion is a first portion, and the method further comprises, in response to determining that the successful login followed one of an unexpected shutdown or a system update: in response to an interaction with the user interface, displaying a second object in the user interface, the second object representing a second portion of the previous session of the operating system, the second object having a selection state; and in response to receiving the indication to restore the previous session, restoring the previous session of the operating system in the current session of the operating system in accordance with the selection state of the second object, wherein the second portion of the previous session is restored in the current session when the selection state of the second object is an active state and the portion is excluded from the current session when the selection state of the second object is an inactive state.

In some aspects, the techniques described herein relate to a method, wherein the object is a first object and the portion is a first portion, and the method further comprises, in response to determining that the successful login followed one of an unexpected shutdown or a system update: in response to receiving an indication that a desktop identifier displayed in the user interface has been selected, displaying a second object in the user interface, the second object representing a second portion of the previous session of the operating system, the second object having a selection state; and in response to receiving the indication to restore the previous session, restoring the previous session of the operating system in the current session of the operating system in accordance with the selection state of the second object, wherein the second portion of the previous session is restored in the current session when the selection state of the second object is an active state and the portion is excluded from the current session when the selection state of the second object is an inactive state.

In some aspects, the techniques described herein relate to a method, wherein the object is a first object and the portion is a first portion, and the method further comprises, in response to determining that the successful login followed one of an unexpected shutdown or a system update: displaying a second object in the user interface, the second object representing a second portion of the previous session of the operating system, the second object having a selection state; displaying a control in the user interface, the control being configured to cause the selection state of the first object and the selection state of the second object to be in one of the active state or inactive state in response to an interaction with a user; and in response to receiving the indication to restore the previous session, restoring the previous session of the operating system in the current session of the operating system in accordance with the selection state of the second object, wherein the second portion of the previous session is restored in the current session when the selection state of the second object is an active state and the portion is excluded from the current session when the selection state of the second object is an inactive state.

In some aspects, the techniques described herein relate to a method, wherein the portion of the previous session includes any of at least one application running in the previous session or at least one setting associated with the at least one application.

In some aspects, the techniques described herein relate to a method, wherein the object displays a screenshot of content associated with the portion of the previous session.

In some aspects, the techniques described herein relate to a method, wherein the method further comprises: displaying a screenshot of the previous session in a window of the user interface.

In some aspects, the techniques described herein relate to a method, wherein the object is displayed as an icon in the window.

In some aspects, the techniques described herein relate to a method, further comprising: for an element associated with a criterion, displaying the element in the user interface when the criterion is satisfied, the element representing a suggestion to perform a task in the current session, the element having a selection state; in response to receiving an indication to restore the previous session, performing the task in accordance with the selection state of the element, wherein the task is performed in the current session when the selection state of the element is an active state and the task is not performed in the current session when the selection state of the element is an inactive state.

In some aspects, the techniques described herein relate to a method, wherein the element includes text reflecting summary information for suggestion.

In some aspects, the techniques described herein relate to a method, wherein the element includes an icon indicative of a source of the suggestion.

In some aspects, the techniques described herein relate to a method, wherein the suggestion is a first suggestion, and wherein displaying the element in the user interface when the criterion is satisfied includes: generating the first suggestion and a second suggestion; and ranking the first suggestion and the second suggestion according to a ranking process to produce a first ranking and a second ranking, respectively, the criterion being satisfied when the first ranking is sufficiently high.

In some aspects, the techniques described herein relate to a method, wherein the first suggestion belongs to a first category and the second suggestion belongs to a second category, and wherein ranking the first suggestion and the second suggestion according to the ranking process includes: locating the first category and the second category in a hierarchy of categories.

In some aspects, the techniques described herein relate to a method, wherein the first suggestion belongs to a first category and the second suggestion belongs to a second category, and wherein ranking the first suggestion and the second suggestion according to the ranking process includes: inputting the first category and the second category into a model configured to produce as output a ranking of the first suggestion and the second suggestion.

In some aspects, the techniques described herein relate to a method, including determining, responsive to a successful login to an operating system, whether the successful login followed one of unexpected shutdown or a system update; in response to determining that the successful login followed one of an unexpected shutdown or a system update: for an element associated with a criterion, displaying the element in a user interface of the operating system when the criterion is satisfied, the element representing a suggestion to perform a task in a current session of the operating system, the element having a selection state; in response to receiving an indication to restore a previous session of the operating system, performing the task in accordance with the selection state of the element, wherein the task is performed in the current session when the selection state of the element is an active state and the task is not performed in the current session when the selection state of the element is an inactive state; and in response to determining that the successful login did not follow one of unexpected shutdown or a system update, displaying a desktop of the operating system.

In some aspects, the techniques described herein relate to a method, wherein the element includes text reflecting summary information for the suggestion.

In some aspects, the techniques described herein relate to a method, wherein the element includes an icon indicative of a source of the suggestion.

In some aspects, the techniques described herein relate to a method, wherein the suggestion is a first suggestion, and wherein displaying the element in the user interface when the criterion is satisfied includes: generating the first suggestion and a second suggestion; and ranking the first suggestion and the second suggestion according to a ranking process to produce a first ranking and a second ranking, respectively, the criterion being satisfied when the first ranking is sufficiently high.

In some aspects, the techniques described herein relate to a method, wherein the first suggestion belongs to a first category and the second suggestion belongs to a second category, and wherein ranking the first suggestion and the second suggestion according to the ranking process includes: locating the first category and the second category in a hierarchy of categories.

In some aspects, the techniques described herein relate to a method, wherein the first suggestion belongs to a first category and the second suggestion belongs to a second category, and wherein ranking the first suggestion and the second suggestion according to the ranking process includes: inputting the first category and the second category into a model configured to produce as output a ranking of the first suggestion and the second suggestion.

In some aspects, the techniques described herein relate to a method, further including: in response to determining that the successful login followed a system update, determining a value of a restore parameter; and responsive to determining the value of the restore parameter indicates asking whether to restore, providing the informed restore and smart suggestions. Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube), LED, OLED, or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

What is claimed is:

1. A method comprising:
receiving an indication to provide a session overview; and
in response to determining to provide the session overview:
identifying suggestions, based on a current time and trigger criteria,
ranking the suggestions based on trigger categories and suggestion sources to produce a ranking, and
presenting suggestion elements representing the suggestions according to the ranking.

2. The method as in claim 1, wherein a trigger category of the trigger categories is a morning category associated with a morning timeframe and the trigger criteria include a combination of the current time falling within the morning timeframe and a suggestion source of the suggestion sources.

3. The method as in claim 1, wherein a trigger category of the trigger categories is an evening category associated with an evening timeframe and the trigger criteria include a combination of the current time being within the evening timeframe and a suggestion source of the suggestion sources.

4. The method as in claim 1, wherein the trigger criteria include a combination of an event occurrence and a suggestion source of the suggestion sources.

5. The method as in claim 1, wherein determining to provide the session overview includes determining that a successful login followed one of an unexpected shutdown or a system update during a previous session.

6. The method as in claim 1, wherein determining to provide the session overview includes determining that a sleep mode or screensaver mode has ended.

7. The method as in claim 1, wherein ranking the suggestions includes:
using a hierarchy of the trigger categories to rank a suggestion having a trigger category low in the hierarchy lower than a suggestion having a trigger category ranked high in the hierarchy.

8. The method as in claim 7, wherein a first trigger category is associated with a first timeframe and a second trigger category is associated with a second timeframe longer than the first timeframe, and wherein the second trigger category is lower in the hierarchy than the first trigger category due to the longer timeframe.

9. The method as in claim 7, wherein a daily trigger category is lower in the hierarchy than a recency trigger category.

10. The method as in claim 1, ranking the suggestions includes inputting the trigger categories and the suggestion sources into a model.

11. The method as in claim 10, wherein the model includes a machine-learned ranking algorithm.

12. The method as in claim 10, wherein the model is trained based on a user interaction history.

13. The method as in claim 10, wherein the model is initialized based on a hierarchy of the trigger categories.

14. The method as in claim 1, wherein the suggestions are identified using a model.

15. A method, comprising:
determining, responsive to a successful login to an operating system, whether the successful login followed one of an unexpected shutdown or a system update;
in response to determining that the successful login followed one of an unexpected shutdown or a system update during a previous session:
displaying an object in a user interface of the operating system, the object representing a portion of a previous session of the operating system, the object having a selection state;
in response to receiving an indication to restore the previous session, restoring the portion of the previous session in a current session when the selection state of the object is an active state and excluding the portion from the current session when the selection state of the object is an inactive state; and
in response to determining that the successful login did not follow one of an unexpected shutdown or a system update, displaying a desktop of the operating system.

16. The method as in claim 15, wherein the portion of the previous session includes any of at least one application running in the previous session or at least one setting associated with the at least one application.

17. The method as in claim 15, wherein the object displays a screenshot of content associated with the portion of the previous session.

18. The method as in claim 15, wherein the method further comprises:
displaying a screenshot of the previous session in a window of the user interface.

19. The method as in claim 18, wherein the object is displayed as an icon in the window.

20. The method as in claim 15, further comprising:
for an element associated with a criterion, displaying the element in the user interface when the criterion is satisfied, the element representing a suggestion to perform a task in the current session, the element having a selection state; and
in response to receiving an indication to restore the previous session, performing the task in accordance with the selection state of the element, wherein the task is performed in the current session when the selection state of the element is an active state and the task is not performed in the current session when the selection state of the element is an inactive state.

21. A computer program product comprising a nontransitory storage medium, the computer program product including code that, when executed by a processor, causes the processor to perform the method as in claim 1.

22. A system comprising:
at least one processor; and
memory storing code that, when executed by the at least one processor, causes the system to perform the method as in claim 1.
